(19) United States
(12) Patent Application Publication
(10) Pub. No.: US 2012/0176311 A1
(43) Pub. Date: Jul. 12, 2012

(54) Optical pointing system and method

(76) Inventors: Steven N. Bittenson, Bedford, MA (US); Gary McAlister, Franklin, MA (US); Alan Bittenson, Bedford, MA (US)

(21) Appl. No.: 13/004,601

(22) Filed: Jan. 11, 2011

(51) Int. Cl. G06F 3/033; G01J 5/10; H01J 40/14

(52) U.S. Cl. 345/158; 250/214.1; 250/338.1

(57) ABSTRACT

Optical pointing systems, devices and methods are provided wherein a selected area on a surface is illuminated with a spot of light generated by an optical pointer, the spot being substantially invisible to unassisted human vision. The spot of light is detected and its position determined via an optical sensor, and a visible marker representing the selected area is provided on the surface, under control of an electronic interface. Surfaces of physical objects as well as displayed images are accommodated, and systems, devices and methods are provided for independent operation, as well as for integrated operation with electronic display and presentation systems.

### FIELD OF THE INVENTION

The invention relates generally to optical pointing devices, systems and methods, and particularly to optoelectronic systems for identifying and indicating a location on one or more surface.

### BACKGROUND

Optical pointing devices, for example, laser pointers, are generally handheld devices that can be used to project a small spot of light along a line of sight to a selected location on the surface of an object. The spot can be moved about on the surface using natural, intuitive gestures with the arm and hand holding the pointing device. Laser pointers, a common type of optical pointer, have nearly replaced physical pointing devices in many applications, for example, in business and academic presentations, where they assist presenters in communicating clearly and expressively with an audience viewing projected or otherwise displayed images. Laser pointers are also commonly used to direct a viewer's attention to features of objects that are out of reach or should not be physically touched. These devices are commercially available in any of a wide range of performance specifications associated with optical power output and color of the emitted light.

Laser pointers have gained their great popularity despite safety concerns associated with the intense, small diameter visible laser beams they project, beams that in some situations can cause eye damage with direct or reflected exposure. Further, the spots of light on surfaces to which the beams are projected are often undesirably small for the viewing audience, and can range in apparent intensity from dimmer than desirable for good visibility, to uncomfortably and distractingly bright, depending in part on ambient lighting conditions and the optical properties of the surface.

For visual presentations to large or geographically distributed audiences, a single electronic image source is often used to transmit image data to two or more projectors or other electronic image displays, providing everyone in an audience with an unobstructed, convenient view of the presentation. An issue associated with using an optical pointer in such a multi-display forum is that the pointer spot appears only on the display screen to which the pointer is directed, leaving the portion of the audience that is viewing another screen unable to see where the presenter is pointing in the image. Although pointing devices such as computer mice can be used to move a cursor about any number of displays, and wireless versions of these devices are commercially available, none provide the ease of use and intuitive pointing associated with an optical pointer.

A need exists for improved pointing devices and systems that provide intuitive optical pointing applicable to multiple displays. Further, there is a need for eye-safe, hand-held pointing devices that provide a visible spot having a size and brightness appropriate for various forums, regardless of the display size, surface properties, and ambient lighting level.

### SUMMARY OF THE INVENTION

The present invention relates to optical pointing devices and systems, and in particular to electronic interface systems for optical pointing.

One aspect of the present invention is a system for pointing to a selected location on a surface. The surface can be any type of surface, including a planar surface or a surface of a three-dimensional object. The surface can display computer-mediated images, projected images, graphical images, paintings, photographs, or any other type of information. The system includes a light-emitting device such as an optical pointer that can be a laser pointer or a pointer based on an incoherent light source. The pointer is generally a hand-held device that is used to manually direct a spot of light from the pointer onto the surface. The spot is substantially invisible to a human viewer, but is detectable and locatable on the surface using an optical sensor. The light-emitting device can be an infrared light emitter, or a visible light emitter producing a visible spot that would generally go unnoticed by a human viewer under expected ambient lighting conditions.

The optical sensor provides an electronic signal for generating a visible marker on the surface to represent the location of the spot. The visible marker can be generated using a light projector directed at the surface, or it can be added to a computer-mediated image that is already being displayed on the surface. The position of the visible marker can coincide with that of the spot, or can be offset from the position of the spot, and the appearance of the marker can be under software control that can include a user interface.

Another aspect of the present invention is a method for visibly indicating a selected location on a surface. The method includes manually pointing an invisible or low-visibility light beam toward the selected location. A light sensor is then used to detect the location where the beam intersects the surface, and a visible indicator is generated to mark the pointed location on the surface. The method can further include manually adjusting the pointing to the surface to move the visible marker to the selected location.

Yet another aspect of the present invention is an optical pointing system for use with a computer or multimedia projector. The system includes a projector that can receive image data for projecting an image onto to a surface, and an optical pointer adapted to project a spot of infrared light to a location onto the displayed image. The system also includes an optical sensor for detecting the location of the spot, and a data interface adapted to transmit the detected location to the computer. The system can also include software for modifying the image data to include a visible marker in the projected image.

### BRIEF DESCRIPTION OF THE DRAWINGS

This invention is described with particularity in the appended claims. The above and further aspects of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIGS. 1a and 1b schematically illustrates an embodiment of a pointing system according to the present invention.

FIG. 2 schematically illustrates an embodiment of an integrated pointing system according to the present invention.

FIG. 3 schematically provides an illustrative example of a plurality of image display devices, spot-locating devices, and optical pointers used in a large-scale pointing system according to the present invention.

FIG. 4 schematically provides an illustrative example of a tour-type pointing system according to the present invention.

FIG. 5 schematically illustrates in a cross sectional view an exemplary embodiment of an optical pointer according to the present invention.

FIG. 6 schematically illustrates an embodiment of a spot-locating device according to the present invention, comprising two orthogonally oriented senor arrays.

### DESCRIPTION

The present invention provides apparatus, systems and methods for optical pointing to a physical object, a feature of an object, or to a selected location on a surface displaying an image. In some embodiments, the object or image is stationary. Such objects and images include but are not limited to works of art or architecture, historical relics, sculptures, technical constructs, photographs, paintings, and any fixed image including projected or otherwise displayed images. In other embodiments, the surface comprises a computer display, a multimedia display, or a projection surface, for presenting a sequence of still images or a video image. In still other embodiments, the object is a moving object or living being.

In an aspect of the invention, an optical pointing device (optical pointer) is provided. The optical pointer can include either or both of an incoherent light source and a coherent light source. In one embodiment, the coherent light source is a solid-state laser source, such as a diode laser adapted to emit a beam of light for projecting a spot of light onto a surface. In another embodiment, the incoherent light source is a light-emitting diode adapted for projecting a spot of light (spot) onto the surface. One or more optical element can be used to modulate, image, or otherwise direct light from the light source to the spot. The one or more optical element can include refractive or reflective optical elements, masks, or optical modulators such as electrooptic or acoustooptic modulators. The spot can have any cross sectional shape. In one embodiment, the cross section of the spot is circular or oval (which can be elliptical), depending in part on an angle of incidence of the light to the surface. In another embodiment, the spot has a noncircular cross section. In yet another embodiment, the intensity of the beam is modulated or pulsed at a predetermined frequency. In a further embodiment, the modulation comprises a coded signal.

The optical pointer is adapted to project a spot that is detectable, and its position measurable (locatable) on the surface by an optoelectronic sensing system, but that under expected ambient viewing conditions would ordinarily go unnoticed by, or be invisible to, members of a human viewing audience (a viewer). We refer to this combination of characteristics of the spot as substantially invisible, but detectable. The sensing system generates an electronic signal representing the sensed position of the spot on the surface. We refer herein to a device or system adapted to detect the spot of light within a field of view, and to generate an electronic signal representative of the spot's position within the field of view, as a spot-locating device.

The electronic signal is in turn used to generate a visible marker on the surface, the marker representing to the viewer the position of the spot on the surface. Whereas prior art optical pointers are generally designed for maximum visibility of a projected spot by human viewers, optical pointers according to the present invention are designed for minimum visibility or invisibility of their projected spot, while providing detectability by the sensing system.

Any means for projecting a substantially invisible, but detectable spot of light on a surface can be used with an optical pointer according to the present invention. One such means is to select the optical pointing device to emit light outside the human visual wavelength range of approximately 390 nanometers (nm) to 750 nm. In an embodiment, the optical pointing device is adapted to emit light at an infrared wavelength (an infrared optical pointer). In one embodiment, the infrared optical pointer emits light at a wavelength in the range of approximately 750 nm to 2000 nm. In another embodiment, the infrared optical pointer emits light at a wavelength generally considered to be eye-safe. Eye-safe is a relative term, and the definition of an eye-safe wavelength (also intensity-dependent) is subject to some debate and study in this art. In one embodiment, the eye-safe wavelength is in the range of approximately 1300 nm to 2000 nm. Solid-state light sources including light emitting diodes and laser diodes are currently commercially available to emit light in a narrow spectral band at a selected one of a variety of infrared wavelengths, including eye-safe wavelengths. Various cameras and other optical detectors responsive to light throughout these wavelength regions are also currently commercially available for use in a spot-locating device according to the present invention.

Any type of spot-locating device can be used in a pointing system according to the present invention. Known devices and systems for identifying the position of a feature or illuminated portion of an image or object generally include a two-dimensional electronic imaging array such as CCD (charge-coupled device) or CMOS (complementary metal-oxide-semiconductor) array for capturing an image of the surface.

Such systems also generally include computer interface electronics, and image recognition software executable to convert electronic data from the imaging array to positional information for the spot. Embodiments of other types of spot-locating devices are also disclosed hereinbelow.

In one embodiment, the optical pointer is used to point to a feature in an image displayed on the surface, and the visible marker is projected onto the surface independently of and superposed on the image, for example, using a light projector to project the visible marker. In another embodiment, the optical pointer is used to point to a feature in an electronically generated or mediated image displayed the surface, and the visible marker comprises an image element integrated with the electronically generated or mediated image. In a further embodiment, the visible marker is a screen cursor in a computer-generated image.

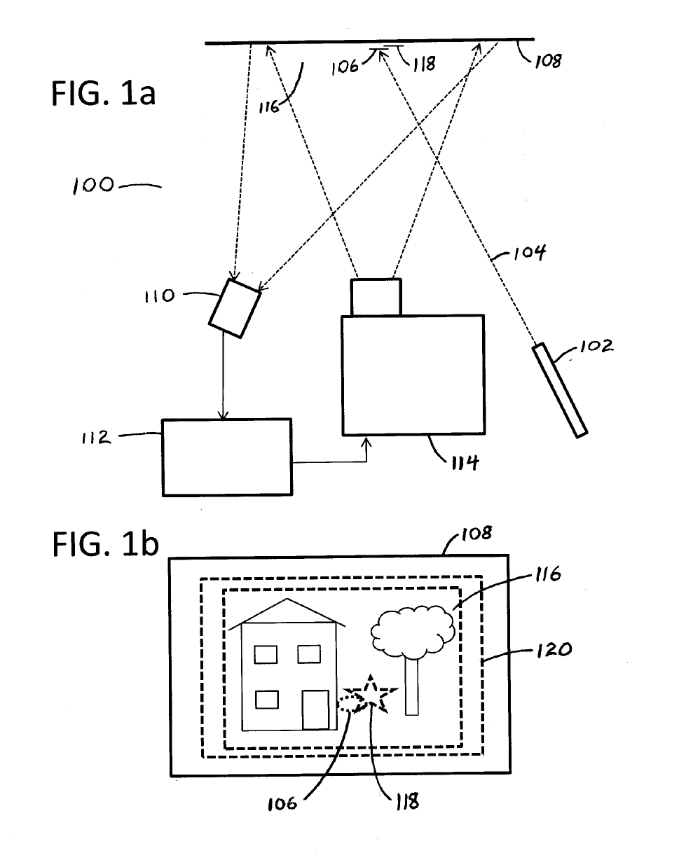

FIGS. 1a and 1b schematically illustrate an embodiment of a pointing system 100 according to the present invention. The system 100 is seen to comprise an optical pointer 102 adapted to emit a beam of light 104 for projecting a substantially invisible, but detectable spot of light 106 onto a surface 108. The system 100 is also seen to comprise a spot-locating device 110 adapted for receiving light scattered from the surface 108, and for detecting and identifying the position of the spot 106 on the surface 108. In an embodiment, the optical pointer 102 emits light at an infrared wavelength and the spot-locating device 110 selectively detects light at the infrared wavelength.

Any wavelength-selective means can be used to selectively detect at the infrared wavelength, including passing the light through a wavelength-selective filter, reflecting the light from a wavelength-selective surface such as a dichroic mirror, and employing an optical sensor that is primarily sensitive at the wavelength. In an embodiment, the light emitted by the optical pointer 102 is amplitude modulated at a predetermined frequency and the spot-locating device 110 is adapted to selectively detect an optical signal modulated at the predetermined frequency. In a further embodiment, the amplitude modulation comprises pulsing of the light emitted by the optical pointer 102. In another embodiment, the modulation of the light emitted by the optical pointer 102 comprises a coded signal.

The pointing system 100 is also seen to comprise a data processor 112 and an image projector 114. By an image projector we mean a device adapted to receive image data from an external source, and convert the data to modulated light that can be projected to a projection surface external to the projector. In an embodiment, the data processor 112 is a microprocessor-based computer adapted to receive spot location data from the spot-locating device 110, and to transmit image data to the projector 114 for projection of an image 116 onto the surface 108. In an embodiment, the data processor 112 is adapted to process data received from the spot-locating device 110 for modifying the image data to include a visible marker 118 that represents the position of the spot 106 on the surface 108. In an embodiment, the visible marker 118 comprises a computer screen cursor.

In an embodiment, one or more of the size, shape, brightness, color and orientation of the visible marker 118 is selectable via a software user interface via the data processor 112, independent of the size, shape, and brightness of the spot 106. The visible marker 118 is intended to represent, and preferably coincide in position with the spot 106, but positional offsets can be introduced through misalignment between the spot-locating device 110 and the surface 108, through errors in detecting the position of the spot 106 by the spot-locating device 110, and through imperfect software positioning of the visible marker 118 in an image. For illustrative purposes, FIGS. 1a and 1b show the visible marker 118 slightly offset from the spot 106.

The system is tolerant of such positional offsets between the spot 106 and the visible marker 118, as the spot 106 is substantially invisible, and as modest positional offset errors are routinely and intuitively corrected by users of optical pointing devices. In an embodiment, the position of the visible marker 118 coincides with the position of the spot 106 on the surface 108. In another embodiment, as illustrated schematically in FIG. 1b, a field of view 120 of the spot-locating device 110 includes an area larger than the area of the projected image 116. In another embodiment, the field of view of the spot-locating device substantially coincides with the image 116.

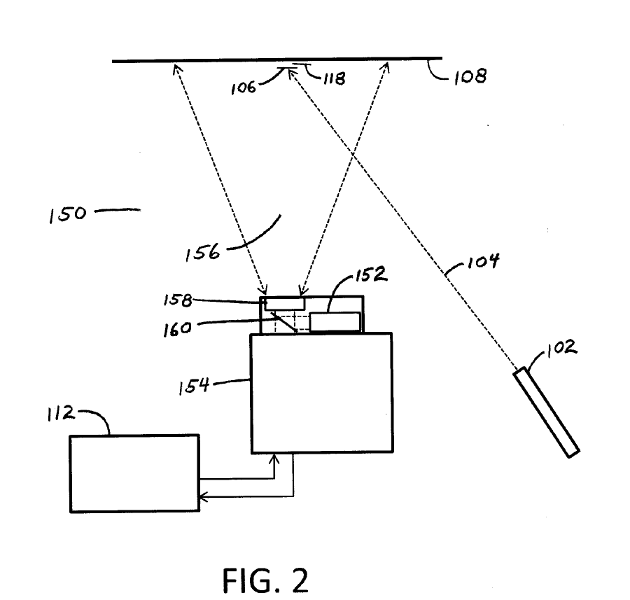

An embodiment of an integrated pointing system 150 according to the present invention is illustrated schematically in FIG. 2. The integrated pointing system 150 resembles the pointing system 100 of FIG. 1a, but in the integrated system 150, a spot-locating device 152 is seen in partial cross sectional view to be physically integrated with an image projector 154. In an embodiment, the spot-locating device 152 and the projector 154 share an optical path 156 between projection optics 158 and the surface 108, and the spot-locating device 152 is seen to receive light scattered from the surface 108, including light from the spot 106, via the projection optics 158 and a beamsplitter 160. In an embodiment, the beamsplitter 160 is wavelength-selective to selectively reflect an emission wavelength of the optical pointer 102 to the spot-locating device 152. In an embodiment, the imaging optics 158 are adapted to transmit light at an infrared wavelength emitted by the optical pointer 102. Any level of integration of a spot-locating device with a display device such as a projector can be used. For example, in another embodiment (not illustrated), the spot-locating device 152 is physically mounted to the projector 154, but the respective optical paths to the surface 108 are independent of one another. In an embodiment, the integrated pointing system 150 is interconnected with the data processor 112 via an integrated cable for transmitting position data from the spot-locating device 152 to the data processor 112, and for transmitting image data from the data processor 112 to the projector 154.

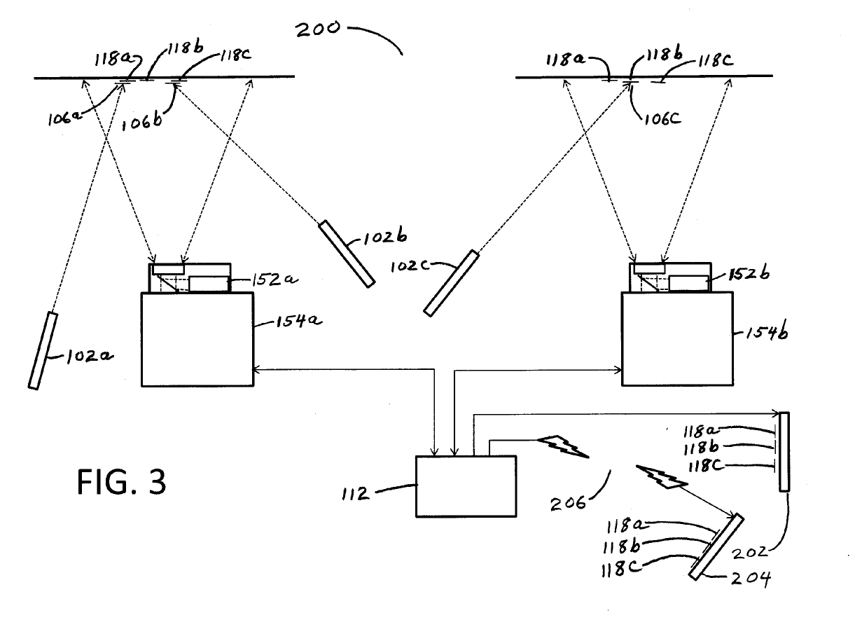

A pointing system according to the present invention can be used to display a visible marker on a plurality of display devices adapted to receive image data from a data processor and display a common image. Any combination of optical pointers, spot-locating devices and displays can be configured according to the present invention. FIG. 3 provides an illustrative example of a plurality of image display devices, spot-locating devices, and optical pointers configured into an exemplary large-scale pointing system 200 according to the present invention. As illustrated in FIG. 3, the data processor 112 is seen to be interconnected with a first 152a and a second spot-locating device 152b, each integrated with a respective first 154a and second projector 154b. Each projector 154a, 154b is seen to be adapted to project an image to a respective projection surface 108a, 108b.

Additional image displays 202, 204 are seen to receive image data from the data processor 112. In an embodiment, all of the display devices 154a, 154b, 202, 204 display substantially the same image as each other. In an embodiment, one or more display 204 is adapted to receive the image data via a wireless connection 206. Pointing systems according to the present invention can include simultaneous use of more than one optical pointer, either where each pointer is used to point at a different display within the field of view of a respective spot-locating device, or where each pointer is individually recognized by the pointing system. In an embodiment, a plurality of optical pointers 102a, 102b, 102c are used independently to point to and project respective spots of light 106a, 106b, 106c on the image at one or more of the image surfaces 108a, 108b, in the field of view of one of respective spot-locating devices 152a, 152b.

In one embodiment, each pointer in the plurality optical pointers 102a, 102b, 102c emits an optically encoded signal that is unique to the specific optical pointer, the encoded signal being detectable by each spot-locating device 152a, 152b, for transmitting respective data signals to the data processor 112. The data processor 112 in turn includes software for generating unique visible markers 118a, 118b, 118c that identify the individual pointers 102a, 102b, 102c. In an embodiment, the optical encoding comprises a unique modulation frequency for each of the plurality of optical pointers 102a, 102b, 102c. In another embodiment, a unique visible marker identifies the person using the respective pointer, for example via an image of the person's name or initials.

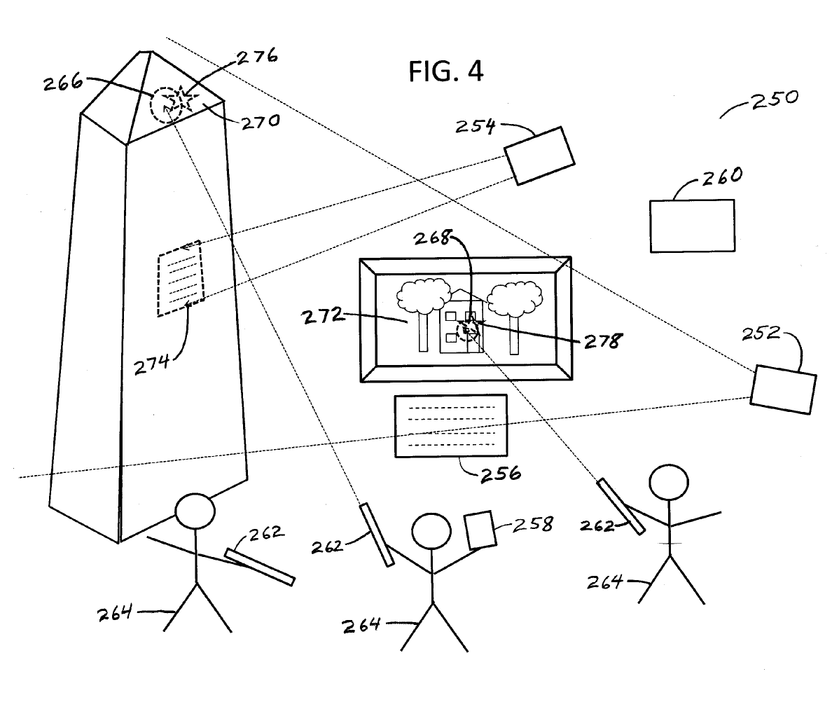

Pointing systems according to the present invention can be used in any environment where it is desirable make information available to visitors, employees, occupants or other persons in the environment. Many different configurations of such pointing and information delivery systems are possible. FIG. 4 schematically illustrates an exemplary embodiment of a tour-type optical pointing system 250 according to the present invention. The tour-type pointing system 250 is seen to comprise one or more spot-locating device 252 according to the present invention and one or more display device 254, 256, 258 that can be any one or more of a projector, a display panel, display goggles, another type of display device, and combinations thereof, as well as audio devices such as speakers and headphones. The tour-type pointing system 250 is also seen to comprise one or more data processor 260. A wired or wireless communications network (not illustrated) interconnects the data processor 260 with at least one of the one or more spot-locating device 252 and at least one of the one or more display devices 254, 256, 258.

The tour-type pointing system 250 additionally is seen to comprise one or more optical pointer 262 according to the present invention. In an embodiment, the one or more optical pointer 262 comprises a plurality of optical pointers, each made available to one of a plurality of visitors 264 to a facility hosting the tour-type pointing system 250. In a further embodiment, one or more of the optical pointers 262 is adapted for wireless communication via the communications network. In an embodiment, the wireless communication comprises at least one of an identification signal for the specific pointer, a locating signal for the pointer's physical location within the facility, and user preferences associated with the specific pointer. Communication systems, including wireless communication systems, electronic coding for identification of a device, and software for handling this type of information are all well known in this art.

In an embodiment, directing spots of light 266, 268 from respective pointers of the plurality of pointers to respective features of interest 270, 272 in the facility results in one of the one or more spot-locating devices 252 identifying the respective features of interest 270, 272 and displaying relevant information via one or more of a projector 254 projecting an image 274 nearby the feature of interest 270, a fixed display 256, or a portable display 258 that can be a portable device carried by the respective visitor of the plurality of visitors 264. In an embodiment, the one or more optical pointing device 262 is an infrared light-emitting optical pointer adapted to provide a projected spot that is invisible to the plurality of visitors 264. In an embodiment respective visible markers 276, 278 are provided as disclosed hereinabove to guide the optical pointing to the respective features of interest 270, 272.

In a further embodiment, the information provided is selectable by each one of the plurality of visitors 264 via the communication network. In a still further embodiment, the information is selectable via an interface integrated with the optical pointing device. In another embodiment, the information includes visual and auditory components. A tour-type pointing system according to the present invention can be used to facilitate self-guided or computer-assisted tours of any type of facility, including but not limited to museums, art galleries, public facilities, historical sites, architectural sites, libraries, educational institutions, or any other locale where it is desirable to selectably provide information to persons in the facility.

A substantially invisible spot of light projected to a surface according to the present invention is much less limited than visible spots projected in known pointing systems, with respect to the spot's size, brightness, cross sectional shape and modulation. For example, known laser pointers generally provide a small diameter, low angular divergence light beam for projecting a bright, optimally visible spot of light onto a remote surface. In contrast, an optical pointer according to the present invention is configured to provide a beam of light for projecting an invisible spot of light onto a surface, where the spot is optimized for detection and location by a spot-locating device. In an embodiment, the area of the spot on the surface is between 0.1 percent and one percent of the area of an image projected onto the surface. In another embodiment, the diameter of the spot is greater than 10 centimeters.

A visible marker provided according to the present invention can have any size or shape for optimal communication with a viewing audience, and in embodiments, can be user-selectable or adjustable via a software interface. In contrast, a typical known visible laser pointer has a minimum output beam diameter of one to two millimeters and an angular divergence of one to two milliradians, and may project a visible spot approximately two to five millimeters in diameter to a typical presentation display surface.

Although the native output beam diameter of a laser pointer can be used in some embodiments of the present invention, an optical pointer according to the present invention can emit a beam of light having any beam diameter that is practical for use in a hand-held pointing instrument. A larger output beam diameter, for example, can provide enhanced user and audience safety compared with a smaller diameter beam of equivalent optical power. In an embodiment, the optical pointer emits a beam of light having a minimum diameter of at least ten mm. In another embodiment, the optical pointer emits a beam of light having a minimum diameter of at least twenty mm. In yet another embodiment, the optical pointer is adapted to have an output angular beam divergence of between about five milliradians and about fifty milliradians. In still another embodiment, the optical pointer is adapted to have an output angular beam divergence of at least ten milliradians. One or more optical lens or other optical element can be used to increase the angular divergence of light emitted by the optical pointer.

For discussion purposes, we herein describe the area of a spot of light illuminating a portion of a surface, as the area comprising approximately 90 percent of the optical energy of the beam of light incident on the surface and producing the spot. Although projected spots from optical pointing devices are generally circular, they can also be elongated in one direction so as to be approximately elliptical in cross section, or can have another shape. A projected spot having any cross sectional shape is intended to be within the scope of the present invention. For clarity in description, without loss of meaning or intent, we use the term diameter of a projected spot of light to mean an average cross-sectional dimension of the spot corresponding to a circular cross sectional area containing approximately 90 percent of the incident beam energy.

In addition to using an infrared light-emitting optical pointer, a low visibility or substantially invisible but detectable spot can be generated according to the present invention by projecting a relatively large area, relatively low brightness spot of light at a visible wavelength. Visible wavelength spots are particularly applicable when the pointing is done under relatively bight ambient lighting conditions, for example, under normal indoor room lighting, or outdoors during daylight hours. Additionally reduced visibility of a visible light spot can be achieved by selecting the light wavelength to be near an extreme of the human visible spectrum where the eye is less sensitive to light, for example, in the far red region of the visible spectrum.

For example, in the spectral range of approximately 690 nm to 740 nm, near the red end of the human visible spectrum, the human eye is several orders of magnitude less sensitive than at peak visual sensitivity wavelengths near 555 nm. Taking the example further, a 730 nm visible wavelength illuminated spot may appear to a viewer to be about a factor of 100 less bright than a spot illuminated at equivalent power at 670 nm.

An actual selection of a visible wavelength for projecting a substantially invisible but detectable spot would include factors associated with ambient lighting, expected colors in the viewing environment, and wavelength sensitivity of the spot-locating device.

Increasing the size of the spot to reduce its brightness can be accomplished using known optical methods. In one embodiment, the optical pointer is a laser pointer comprising a one or more lens that increases the diameter of a projected spot from a laser diode in the pointer, relative to a native output beam of the laser diode. In a further embodiment, the angular divergence of the laser pointer is increased at least by a factor of five by the one or more lens, relative to the native output beam of the laser diode. In another embodiment, the optical pointer includes an incoherent visible light source that is imaged to a surface to generate a spot of light.

In addition to minimizing the visibility of a spot projected by an optical pointer, it is desirable within the present invention to optimize the detectability of the spot. One means to enhance the detectability of the spot is to amplitude modulate the light emitted by the optical pointer at a predetermined modulation frequency, and to detect the frequency in a spot-locating device. This known detection method is commonly used to improve signal-to-noise ratios when measuring electronic signals. In an embodiment, the optical pointer is one of amplitude modulated and pulsed at a predetermined frequency. In a further embodiment, the frequency is between approximately 100 Hertz (Hz) and 100 kilohertz (kHz). In another embodiment, the modulation comprises a coded signal that is detectable by the spot-locating device.

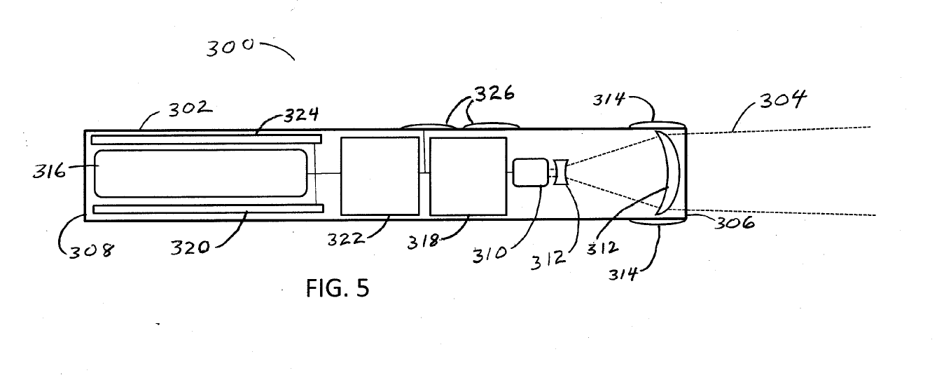

FIG. 5 schematically illustrates a cross-sectional block diagram of an exemplary embodiment of an optical pointer 300 according to the present invention. The pointer 300 is seen to comprise a housing 302 configured for manually pointing a beam of light 304 toward a remote target (not shown in the figure). The housing 302 can have any physical shape and size convenient for use as a handheld pointer. In an embodiment at least a portion of a length of the housing 302 is cylindrical in cross section. In another embodiment the housing 302 is longitudinally elongated in profile and has a substantially cylindrical cross sectional shape having a maximum outer diameter of between one and five centimeters.

As illustrated in FIG. 5, the housing 302 is seen to have a first end 306 and a second end 308. The beam of light 304 is generated by a light-emitting element 310 that can be either an incoherent light-emitting element or a coherent light-emitting element. In one embodiment the light-emitting element 310 is a light-emitting diode. In another embodiment the light-emitting element 310 is a laser diode. In still another embodiment the light-emitting element 310 is a selectively infrared light-emitting element. Light emitted by the light-emitting element 310 is seen to be directed out the first end 306 to form the beam 304. In one embodiment (not illustrated), the light emitted by the light-emitting element 310 is directed out the first end 306 without modification to comprise the beam 304. In another embodiment, light emitted by the light-emitting element 310 exits the first end 306 via one or more optical element 312 that modifies at least one of a diameter and an angular divergence of the emitted light, or optically images the light-emitting element 310 to the remote target. In another embodiment, the one or more optical element 312 comprises an optical modulator that imposes a periodic intensity modulation on the emitted light. In an embodiment the one or more optical element 312is adapted make the beam 304 divergent at all distances after exiting the first end 306.

Optical pointers according to the present invention are configured to emit pointing light that is minimally visible or invisible to human viewers. In an embodiment, the pointer 300 comprises one or more visible light emitter 314 to indicate to a user when the pointer 300 is emitting the beam 304. The housing 302 is seen to also include an electrical power storage unit 316 coupled to the light-emitting element 310 via a power conditioning unit 318. The power storage unit 316 can comprise a battery, a capacitor, or any other type of rechargeable or disposable electrical energy storage device. In an embodiment, the power storage unit 316 is rechargeable via an inductive charging device 320 configured to receive power from an external inductive charger (not illustrated).

The power conditioning unit 318 can be active or passive. In an embodiment, the power conditioning unit 318 includes active electronics for modulating the electrical power delivered to the optical emitter 310 at a predetermined frequency, thereby modulating an intensity of the beam 304.

In other embodiments, the pointer 300 includes communication electronics 322 and an antenna 324 for communicating via a wireless network (not illustrated). In various embodiments, communication with the wireless network comprises one or more of communicating user preferences for a mode of operation of the pointer 300, and communicating the physical location of the pointer 300. The pointer 300 can also include one or more input device 326 that can be an electrical switch or another type of input device, for example, for turning power to the pointer 300 on or off, or for sending communications via the wireless network.

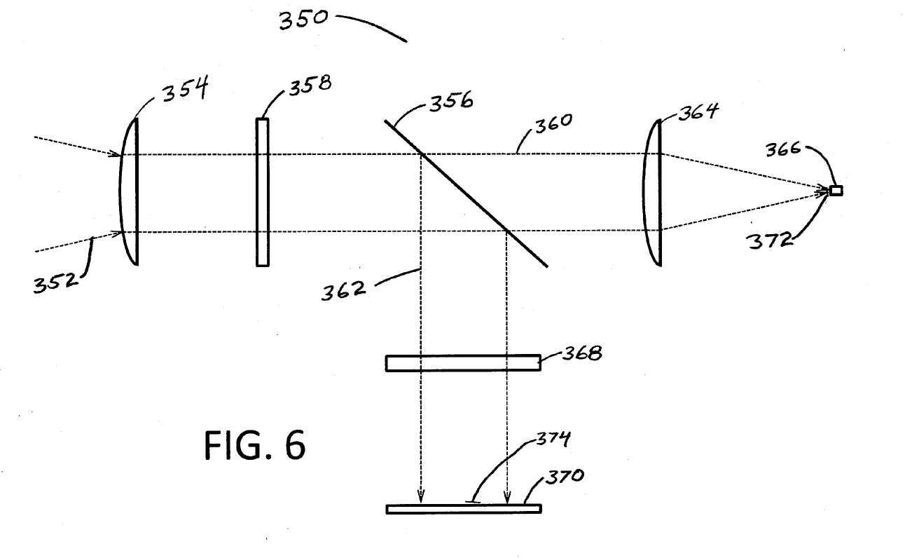

FIG. 6 schematically illustrates an embodiment of a spot-locating 350 device according to the present invention wherein the position of a spot of light directed to a surface by an optical pointer according to the present invention is detected using mutually orthogonally oriented longitudinal arrays of optical sensors. Longitudinal (typically linear) array optical sensors are known in this art. The spot-locating device 350 is seen to receive light 352, including light scattered at the spot of light, via imaging optics 354 that direct the light 352 to a beamsplitter 356. In an embodiment, a wavelength-selective component 358 selectively admits light to the spot-locating device 350 at wavelengths of light emitted by the optical pointer. The wavelength-selective component 358 can be a discrete optical component such as a filter, or integrated with another component of the spot-locating device 350, for example as a wavelength-selective bulk material or as a wavelength-selective coating on another component.

The beamsplitter 356 substantially equally divides the light 350 into a transmitted 360 and a reflected component 362. The transmitted component 360 of the light 352 is seen to be focused by a first cylindrical lens 364 to a line image at a first longitudinal sensor array 366 (oriented perpendicular to the page in FIG. 6), and the reflected component 362 of the light 352 is seen to be focused by a second cylindrical lens 368 to a line image at a respective second longitudinal sensor array 370 (oriented in the plane of the page in FIG. 6). The relative orientations of the respective lenses 364, 368 and sensor arrays 366, 370 provide sensing along mutually orthogonal cross-sectional axes of the received light 352. Any means to provide mutually orthogonal sensing axes can be used. In another embodiment, line focusing of light to one or both of the sensor arrays 366, 370 is accomplished using reflective optics rather than lenses.

In yet another embodiment, two or more of the functions of imaging, beamsplitting, focusing and wavelength selection are integrated into a single optical component. In a further embodiment, one or both of the sensor arrays 366, 370 is mounted directly to the single optical component. By focusing the received light 352 to line images at the respective longitudinal sensor arrays 366, 370, the intensity of focused light delivered to each array can be advantageously higher than that of light imaged onto a two-dimensional array, thereby providing increased sensitivity of the spot-locating device 350. To identify the position of the spot in a field of view of the spot-locating device 350 and imaged 372, 274 onto both sensor arrays 366, 370, electrical signals from the sensor arrays 366, 370 are processed to identify maxima associated with the spot, along the respective axes, thereby providing orthogonal coordinates for the spot in the field of view. This signal processing is significantly simpler than is the case for spot locating devices comprising two-dimensional imaging arrays that require image-recognition software to function.

The present invention can be used for optical pointing to any type of electronic data display. In an embodiment, the display is a flat-panel multimedia display or computer display. In one embodiment, a spot-locating device images the display to locate a spot emitted by the optical pointer in the manner disclosed hereinabove. In another embodiment, the spot-locating device comprises light sensing at the image surface of the display. In one embodiment, the light sensing comprises a sensing layer applied to the image surface. In another embodiment, the light sensing is integrated into the display.

Advantageously, pointing systems according to the present invention enable a user to employ the natural, intuitive pointing motions associated with a laser pointer in a multidisplay presentation environment. Further, the brightness, color, size and shape of a visible marker associated with the pointing is under software control and can be customized for any type of display and ambient lighting conditions. In addition, multiple pointers according to the present invention can be used in a computer presentation environment, each providing a unique signature on one or more display. The unique signature can include personal identification of a person using a pointer. This can be particularly advantageous over visible multi-pointer systems, where distinguishing among multiple pointers can be inconvenient, impractical, or present eye-safety issues.

A pointing system according to the present invention can also be used advantageously in computer or self-guided tour environments. By using substantially invisible, pointing beams, a plurality of visitors can freely point respective pointing devices at features of interest in a facility without distracting or interfering with the tour experience of others. In addition, whereas visible optical pointers are not permitted in many facilities, substantially invisible pointing of the present invention provides opportunities for tourists or others to individually select specific objects of their interest, and to acquire specific information to meet individual requirements. Further, by recording the selections of visitors to a facility, information-gathering organizations can learn more about the interests of their patrons.

Also advantageously, pointing systems according to the present invention can provide improved safety for users and viewers relative to visible pointing systems. In addition to reducing distractions due to inadvertent pointing of visible light beams, especially where multiple optical pointers may be in use, optical pointers according to the present invention are designed specifically for invisibility or minimum visibility to unaided human vision. The inventive optical pointers are optimized for detectability using optoelectronic sensing, enabling larger diameter and greater angular divergence light beams to be used, relative to the bright, small diameter, low divergence laser beams emitted by visible optical pointers, reducing eye damage hazards.

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A system for pointing to a selected location on a surface, the system comprising:
a) a light-emitting device adapted for manually directing a spot of light onto the surface, the spot defining a first location on the surface, the spot being substantially invisible to unassisted human vision,
b) an optical sensor adapted to convert light emitted by the light-emitting device and scattered at the first location, to an electronic signal representing the first location; and
c) means for generating a visible marker on the surface in response to the electronic signal, the visible marker comprising the selected location.

2. The system according to claim 1 wherein the means for generating the visible marker comprises a light projector adapted to project the marker onto the surface.

3. The system according to claim 1 wherein the surface comprises a computer-mediated image, and the means for generating a visible marker comprises a computer interface adapted to modify the computer-mediated image to include the visible marker.

4. The system according to claim 3 further comprising a projector adapted to project the computer-mediated image onto the surface.

5. The system according to claim 1 wherein the surface comprises at least one of a projected image, a graphical image, a painting, a photograph, and a surface of a three-dimensional object.

6. The system according to claim 1 wherein the light-emitting device is an infrared light-emitting optical pointer.

7. The system according to claim 1 further comprising an electronic display for displaying information, the information content being determined by an identification of the selected location via the optical sensor.

8. The system according to claim 1 wherein at least one of a color, a brightness, a cross sectional dimension and a cross sectional shape of the visible marker is determined independently of a cross sectional dimension, a cross sectional shape, an illumination wavelength and an illumination intensity of the spot.

9. The system according to claim 1 wherein the optical sensor is adapted to selectively detect light at a wavelength of light emitted by the light-emitting device.

10. A method for visibly indicating a selected location on a surface, the method comprising:
a) manually pointing a light beam source toward a first location on the surface, the first location estimated to be proximate to the selected location, the light beam producing a spot of light on the surface, the spot being substantially invisible to a human viewer;
b) detecting the first location on the surface with one or more light sensor;
c) projecting a visible indicator of the first location onto the surface.

11. The method according to claim 10 further comprising manually adjusting the pointing of the light beam source to position the visible indicator at the selected location.

12. The method according to claim 10 further comprising modifying one or more of a size, a shape, a color and a brightness of the visible indicator via a software interface.

13. The method according to claim 10 further comprising displaying information via an electronic display, the content of the information being determined in response to the detected location.

14. The method according to claim 10 wherein the light beam source is an infrared light source.

15. An optical pointing system comprising:
An image projector configured to receive image data from an image data source and to display a corresponding image on a projection surface external to the projector; an optical pointer adapted to project a spot of infrared light to a location on the displayed image; an optical sensor configured to detect the location of the spot; and a data interface configured to transmit the detected location to the image data source for modifying the image data to include a graphical representation of the detected location of the spot.

16. The system according to claim 15 wherein the optical pointer comprises an infrared laser.

17. The system according to claim 15 wherein the optical sensor is physically integrated with the projector.

18. The system according to claim 15 further comprising a second projector configured to receive the image data from the image data source and to display a respective second image on a respective second projection surface external to the second projector
